(19) United States
(12) Patent Application Publication
(10) Pub. No.: US 2011/0213576 A1
(43) Pub. Date: Sep. 1, 2011

(54) METHOD FOR CALCULATING THE CHARGE STATE OF A BATTERY

(76) Inventors: Juergen Motz, Steinheim An Der Murr (DE); Eberhard Schoch, Stuttgart-Feuerbach (DE); Burkhard Iske, Renningen-Malmsheim (DE); Chritian Schmitz, Stuttgart (DE)

(21) Appl. No.: 13/061,469

(22) PCT Filed: Jul. 6, 2009
(86) PCT No.: PCT/EP09/58508

§ 371 Date: May 4, 2011

(30) Foreign Application Priority Data
Aug. 26, 2008 (DE) 10 2008 041546.4

(51) Int. Cl. G06F 19/00

(52) U.S. Cl. 702/63

(57) ABSTRACT

In a method for ascertaining the charge state of a battery based on its open circuit voltage which may be determined using various methods, the accuracy of the charge state calculation may be optimized if the error of the open circuit voltage, which would result from applying a first and at least one additional method for open circuit voltage determination, is calculated, and the charge state is ascertained based on the particular open circuit voltage, the error of which is smaller than the error, which would result from applying another method for determining the open circuit voltage.

### FIELD OF THE INVENTION

The present invention relates to a method for ascertaining the charge state of a battery and a control unit.

### BACKGROUND INFORMATION

The charge state of the battery SOC (state of charge) is an important parameter for the electrical system management of vehicles. Many vehicles have so-called battery state recognition for determining the charge state. This battery state recognition normally includes an algorithm which calculates charge state SOC, e.g., from a theoretical open circuit voltage U₀. Theoretical open circuit voltage U₀ is in turn calculated from an initial value U₀₀ and the integral of battery current I_{Batt}, taking various loss factors into account, if necessary. The following equation applies, for example, to theoretical open circuit voltage U₀:

U₀=U00+1/C₀·∫I_{Batt}dt (1)

where C₀ is the equivalent capacitance of the battery and U₀₀ is the initial or starting value of the open circuit voltage. Starting value U₀₀ is normally estimated from the measured values of battery voltage U_{Batt}, battery current I_{Batt} and battery temperature T_{Batt}.

This calculation of open circuit voltage U₀ still delivers relatively precise results at the beginning of the integration. However, one disadvantage of this calculation is the deviation of the calculated charge state from actual charge state SOC, which increases constantly over time, due to the integral component of equation (1). This error propagates itself in the calculation of charge state SOC of the battery in which: SOC=f(U₀).

### SUMMARY

Example embodiments of the present invention provide a method and a device which may be used to determine charge state SOC of a battery more precisely.

An aspect of example embodiments of the present invention is that various methods for calculating the charge state of a battery are analyzed and an error which would result from applying the individual calculation methods is calculated. According to example embodiments of the present invention, charge state SOC of the battery is finally determined based on the calculation or estimation method whose error is smaller than the error which would result from applying a different method. This has the significant advantage that it is possible to determine the charge state relatively precisely.

According to example embodiments of the present invention, at least one method is applied which calculates charge state SOC based on the open circuit voltage of the battery. Should it turn out in this case that the error of the open circuit voltage according to a first calculation method is greater than the error of the open circuit voltage when calculated according to another method, charge state SOC of the battery is ascertained based on the second open circuit voltage. Conversely, if the error of the first method (e.g., corresponding to equation 1) is smaller than the expected error which would result from applying another method, the open circuit voltage is calculated based on the first method. The ascertained value of the open circuit voltage may, for example, be used as the initial value in equation (1).

Charge state SOC of the battery is preferably determined using the method having the smallest error. If the open circuit voltage is calculated according to equation (1), various loss factors may be considered.

A second conventional method for determining the open circuit voltage is to estimate the open circuit voltage from the battery terminal variables, namely battery voltage U_{Batt}, battery current I_{Batt}, and battery temperature T_{Batt}. This preferably takes place in rest phases of the battery in which the battery is not under load or is only under a slight load and thus there is only a minimum battery current flow. According to example embodiments of the present invention, the error which would result from applying this method is preferably also calculated. This error is then compared to the error which would result from calculating the open circuit voltage according to the integration method (corresponding to equation (1)) or another method.

A third conventional method for determining the open circuit voltage is to determine the open circuit voltage when the battery is fully charged. In this case, the charge current of the battery is evaluated and if it corresponds roughly to the gassing current of the battery, the battery is assumed to be fully charged. The open circuit voltage of the battery is then set to a value close to a maximum possible open circuit voltage of the battery. An associated error may also be ascertained for this method. This error is then compared to the error of one or a plurality of determination methods and depending on the size of the error the open circuit voltage determined according to one or another method is used for calculating charge state SOC of the battery.

Example embodiments of the present invention will be explained in greater detail below with reference to the appended drawings.

### BRIEF DESCRIPTION OF THE DRAWINGS

FIG. 1 shows a schematic representation of a battery having a control unit connected to it for calculating the charge state of the battery.

FIG. 2 shows a flow chart including the most important method steps of a method for determining the open circuit voltage and the charge state of the battery.

### DETAILED DESCRIPTION

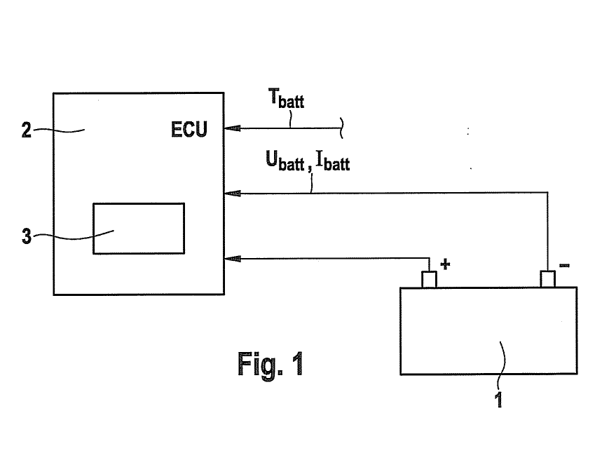

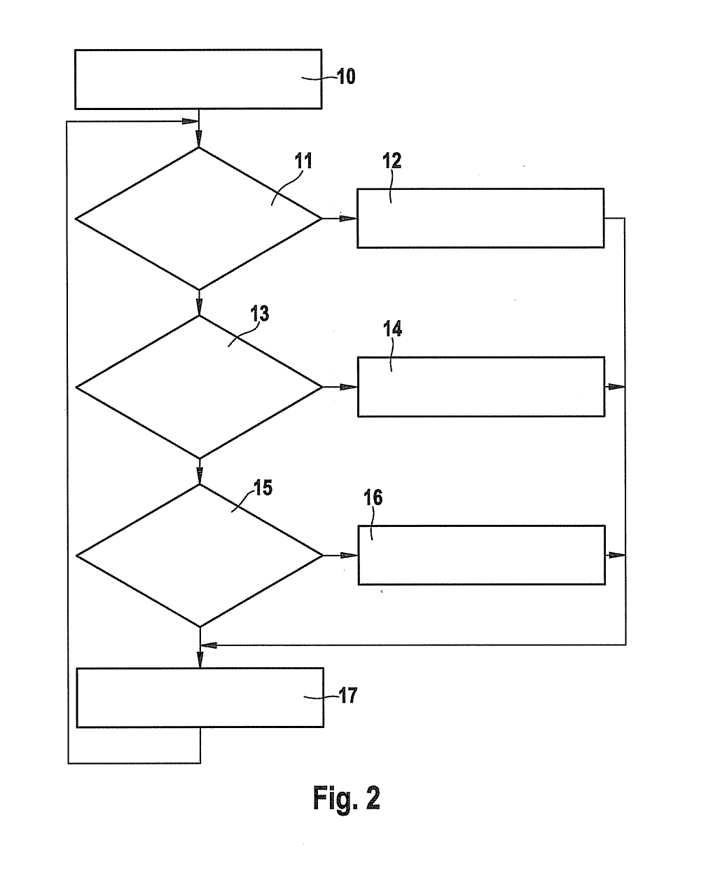

FIG. 1 shows a schematic view of a battery 1 having a control unit 2 connected to it. Control unit 2 includes an algorithm 3 for determining open circuit voltage U₀ of battery 1 using a method which will be explained in greater detail below based on FIG. 2. Algorithm 3 finally calculates charge state SOC of battery 1 from open circuit voltage U₀.

In the method of FIG. 2, initial value U₀₀ of open circuit voltage U₀ of equation (1) and associated error err_U₀ are first set to corresponding starting values (Index init) in a step 10. After that, the error resulting from the integral method (corresponding to equation (1)) is compared in step 11 to the error which would result from applying the second method mentioned at the outset.

The error of theoretical open circuit voltage U₀, which would result from calculating the open circuit voltage according to the integral method (equation (1)), may be estimated as follows:

$${err\_U}_{0} = {err\_U}_{00} + \frac{1}{{C}_{0}} \int ( \vert {err\_I}_{offset} \vert + \vert {I}_{loss} \vert ) d t + \vert {U}_{0} - {U}_{00} ( {err\_I}_{gain} + \frac{{err\_C}_{0}}{{C}_{0}} ) \vert \qquad ( 2 )$$

where err_U₀₀ is the estimated error for U₀₀ in V, err_I_{offset} is the offset error of the current sensor in A, err_I_{gain} is the linearity error of the current sensor, Iₗₒₛₛ is the estimated loss current which can no longer be recovered by discharging in A and err_C₀ is the determination error of the equivalent capacitance in F.

Error err_U₀ estimated in this manner increases continuously during the operating time as a result of the integration.

In order to calibrate open circuit voltage U₀ from time to time, the method of steps 11 through 17 is performed in the following. In this connection, it is first checked in step 11 if it was possible to determine an open circuit voltage U₀ from the battery terminal variables, namely battery voltage U_{Batt}, battery current I_{Batt} and battery temperature T_{Batt}. This is normally possible only in operating phases in which battery 1 is not under a load or is only under a slight load, i.e., the battery current is roughly equal to zero.

Moreover, it is checked in step 11 if the calculation error from the integration method err_U₀ (corresponding to equations (1)) is greater than error err_U₀₀_{_{—}}_{open circuit}, which would result from calculating open circuit voltage U₀ according to the aforementioned second method (Index open circuit). The following applies to error err_U₀₀_{_{—}}_{open circuit}:

$${err\_U}_{0 \_ opencurcuit} = {err\_U}_{Batt} + {err\_I}_{Bat} \frac{d}{d {l}_{Bat}} {U}_{pol} ( {I}_{Batt} , {T}_{Batt} ) + {err\_T}_{Bat} \frac{d}{d {T}_{Batt}} {U}_{pol} ) ( {I}_{Batt} , {T}_{Batt} ) err\_etrapol \_err \_strat \qquad ( 3 )$$

where err_U_{Batt} is the measurement error of the voltage sensor in V, err_I_{Batt} is the measurement error of the current sensor in A, err_T_{Batt} is the measurement error of the temperature sensor in K, err_extrapol is the estimated determination error based on dynamic transients in V, err_strat is the estimated determination error due to built up electrolyte stratification, and Uₚₒₗ is the calculated compensation voltage based on the closed circuit current and the temperature.

If error err_U₀ is greater than possible error err_U₀₀_{_{—}}_{open circuit} (yes case), initial value U₀₀ of equation (1) is set to value U₀₀_{_{—}}_{open circuit}, which results from the estimation method, in step 12. In addition, error value err_U₀₀ is set to error value err_U₀₀_{_{—}}_{open circuit} of the estimation method. Furthermore, the SOC integration which is finally performed in step 17, for example, according to equation (1), is reset.

If one of the conditions of step 11 is not true (no case), it is checked in step 13 if the calculation error from the integration method err_U₀, (corresponding to equations (1)) is greater than error err_U₀₀_{_{—}}_{fullcharge}, which would result from application of the third method (full charge detection) mentioned at the outset. However, it is first determined if battery 1 is fully charged. A full charge is normally assumed if the charge current of the battery drops in relation to the assumed gassing current of the battery. In this case, open circuit voltage U₀ is simply set to a value close to the maximum open circuit voltage.

The error of this third method (Index fullcharge) may be determined, for example based on measurement series across a characteristic map:

err_{—}U₀₀_{_{—}}_{fullcharge}=f(U_{batt}, T_{batt}, t_{charge})

where t_{charge} is the duration of the charging phase in s.

If error err_U₀ in step 13 is greater than error err_U₀₀_{_{—}}_{fullcharge} (yes case), open circuit voltage U₀ is determined in step 14 according to the full charge method described above, and initial value U₀₀ of equation (1) is set to this value U₀₀_{_{—}}_{fullcharge}. Furthermore, error err_U₀₀ is set to the corresponding error err_U₀₀_{_{—}}_{fullcharge} and the SOC integration is reset.

If the conditions predefined in step 13 are not met (no case), it may be checked in step 15 if a result of additional methods for open circuit voltage calculation are present. After that, the associated error value is compared to error value err_U₀ and values U₀₀ and err_U₀₀ are adjusted accordingly in step 16, if necessary.

If no additional methods for determining the open circuit voltage are provided, steps 15 and 16 are skipped.

After that, the method branches back to step 11.

1 to 7. (canceled)

8. A method for ascertaining a charge state of a battery, comprising:
calculating an error which would result from applying a first and at least one second method for determining the charge state;
ascertaining the charge state using the method, the error of which is smaller than the error, which would result from applying another method.

9. The method according to claim 8, wherein the error of an open circuit voltage which would result from integrating the battery current over time is calculated.

10. The method according to claim 8, wherein the error of an open circuit voltage, which would result from calculating the open circuit voltage from a terminal voltage, a battery current, and a battery temperature in a rest phase of the battery, is calculated.

11. The method according to claim 8, wherein the error of an open circuit voltage, which would result from calculating the open circuit voltage from a full charge detection of the battery, is ascertained.

12. The method according to claim 8, wherein the error from an integration of a battery current is compared to the error from a calculation of an open circuit voltage.

13. The method according to claim 8, wherein the error from an integration of a battery current is compared to the error, which would result from a full charge detection.

14. A control unit configured to perform a method for ascertaining a charge state of a battery, the method including
calculating an error which would result from applying a first and at least one second method for determining the charge state;
ascertaining the charge state using the method, the error of which is smaller than the error, which would result from applying another method, comprising including an algorithm for implementing one of the aforementioned methods.
